(19) United States
(12) Patent Application Publication
(10) Pub. No.: US 2009/0259476 A1
(43) Pub. Date: Oct. 15, 2009

(54) DEVICE AND COMPUTER PROGRAM PRODUCT FOR HIGH FREQUENCY SIGNAL INTERPOLATION

(75) Inventor: Yasushi Sato, Kitakyushu-shi (JP)

Correspondence Address: BUCHANAN, INGERSOLL & ROONEY PC, POST OFFICE BOX 1404, ALEXANDRIA, VA, 22313-1404, US

(73) Assignee: Kyushu Institute of Technology, Kitakyushu-shi (JP)

(21) Appl. No.: 11/996,174

(22) PCT Filed: Jul. 13, 2006
(86) PCT No.: PCT/JP2006/313954

§ 371 Date: Jan. 18, 2008

(30) Foreign Application Priority Data
Jul. 20, 2005 (JP) 2005-210124

(51) Int. Cl. G10L 19/00

(52) U.S. Cl. 704/500

(57) ABSTRACT

There are provided a high frequency signal interpolation method and a high frequency signal interpolation device for forming a preferable high frequency signal with a simple configuration and favorably performing practical high frequency signal interpolation.

Therefore, according to the present invention, a compressed digital audio signal reproduced from a digital audio device is supplied as a raw signal to an input terminal 1. The raw signal is supplied, for example, to a Hilbert conversion circuit 2 for generating an analytic signal. A real part R and an imaginary part I of the analytic signal are taken out, independently. Furthermore, the real part R and the imaginary part I are supplied to square circuits 3 and 4, respectively. Subsequently, squared signals are added in an adder circuit 5, respectively. The added signal is supplied to a square-root circuit 6 and an envelope component of the raw signal is taken out. A harmonic component is formed in the envelop component. Thus, a high-harmonic portion of the envelope component taken out at the square-root circuit 6 is taken out by a high-pass filter (HPF) 7. On the other hand, a signal from which a high frequency portion of the raw signal from the input terminal 1 is removed by a low-pass filter 8 is formed. These signals are added by an adder circuit 9 and then output to an output terminal 10.

Accordingly, the interpolation is carried out by forming the envelope component of the raw signal using the real part and the imaginary part of the analytic signal of the raw signal; and taking the high-harmonic portion out of the formed envelope component. Therefore, a favorable high frequency signal is formed by an extremely simplified configuration and practical high frequency signal interpolation can be carried out.

### TECHNICAL FIELD

The present invention relates to a computer program product for high frequency signal interpolation and a high frequency signal interpolation device, which are suitably used in digital audio systems with compression operations, such as one with MP3, telephone systems, and so on. In particular, the present invention relates to a computer program product for high frequency signal interpolation and a high frequency signal interpolation device, which are capable of interpolating a high frequency signal that is missing due to compression or the like.

### BACKGROUND ART

As a means for generating an interpolation signal by the frequency conversion of a signal to be interpolated with a conventional high frequency signal interpolation technique, for example, one disclosed in Japanese Unexamined Patent Application Publication No. 2004-184472 (hereinafter, referred to as Patent Document 1) has been known in the art.

In addition, as a means for simulating high frequency signal interpolation with the addition of a high frequency signal that does not correlate with a raw signal, for example, one disclosed in Japanese Unexamined Patent Application Publication No. 1-131400 A (hereinafter, referred to as Patent Document 2) has been known in the art.

In other words, conventionally, the high frequency signal interpolation has been carried out by the generation of an interpolation signal with frequency conversion and the addition of a high frequency signal without correlation with a raw signal.

Here, in recent years, audio data for representing sounds of music and so on have been actively used by the distribution of the audio data via networks, such as the Internet, and the recording thereof on recording media, such as mini-disks (MD). In this way, from the audio data to be distributed via networks and recorded on recording media, any component with a frequency higher than a predetermined level is generally removed from a music or the like intended to be supplied so as to prevent the audio data from an increase in the amount thereof due to an excessively extended band and from the expansion of an occupied bandwidth.

In other words, for example, frequency components of about 16 kHz or more are removed from audio data of MP3 (MPEG1 audio layer 3) format. In addition, frequency components of about 14 kHz or more are removed from audio data in the form of ATRAC3 (Adaptive Transform Acoustic Coding 3).

The removal of a frequency component at a high frequency is carried out because any frequency component at a frequency over an audible range may not be required with respect to the relation between the audio range and the human's hearing. However, it has been figured out that, as described above, a signal from which a frequency component at a high frequency is completely removed slightly changes the quality of a sound and leads to the degradation of sound quality compared with an original music or the like.

Therefore, the technologies described in Patent Documents 1 and 2 as described above interpolate removed high frequency signals, respectively. The technology described in Patent Document 1 requires a complicated configuration of a circuit, such as the use of a digital signal Processor (DSP) for frequency conversion. In addition, the technology described in Patent Document 2 cannot obtain a sufficient effect because a high frequency signal is not correlative.

The present invention has been made in consideration of these problems and intends to attain the interpolation of a high frequency signal more favorably with a simplified configuration.

### DISCLOSURE OF THE INVENTION

For solving the above problems and attaining the object of the present invention, the invention described in claim 1 is a computer program product for high frequency signal interpolation for allowing a computer to realize a function of obtaining a real part and an imaginary part of a raw signal; a function of forming an envelope component of amplitude of the raw signal using the real part and the imaginary part; and a function of taking out a high-harmonic portion of the envelope component and adding the high-harmonic portion to the raw signal.

In addition, for attaining the object of the present invention, the invention as described in claim 2 is a high frequency signal interpolation device including: a means for forming an envelope component of amplitude of a raw signal supplied to an input terminal using a real part and an imaginary part of the raw signal; a means for taking out a high-harmonic portion of the formed envelope component; and a means for adding the taken-out high-harmonic portion to the raw signal supplied to the input terminal.

Furthermore, in the high frequency signal interpolation device as described in claim 3, the means for forming the envelope component includes a means for obtaining the squares of the real part and the imaginary part of the raw signal respectively and adding the squares to each other, and obtaining a square root of a value resulting from the addition.

In addition, in the high frequency signal interpolation device as described in claim 4, the raw signal supplied to the input terminal is supplied to the adding means via a means for carrying out band limitation while excluding the high-harmonic portion.

Furthermore, in the high frequency signal interpolation device as described in claim 5, the band limitation is carried out while the high-harmonic portion is excluded from the raw signal supplied to the input terminal.

### BRIEF DESCRIPTION OF DRAWINGS

FIG. 1 is a block diagram representing a configuration of an embodiment of a device to which the computer program product for high frequency signal interpolation and the high frequency signal interpolation device in accordance with the present invention are applied;.

FIG. 2 is a waveform chart for illustrating such an embodiment.

FIG. 3 is a block diagram representing a configuration of an embodiment of a Hilbert conversion circuit.

### BEST MODE FOR CARRYING OUT THE INVENTION

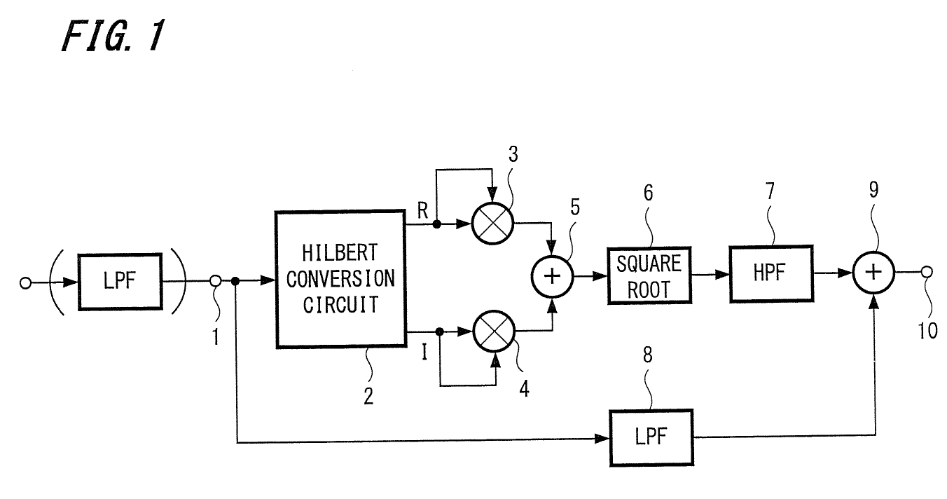

Hereinafter, the present invention will be described with reference to the attached drawings. FIG. 1 is a block diagram illustrating the configuration of a device as an embodiment to which the computer program product for high frequency signal interpolation and the high frequency signal interpolation device of the present invention are applied.

In FIG. 1, a digital audio signal compressed according to MP3, ATRAC3 or the like and reproduced from a digital audio device is supplied as a raw signal to an input terminal 1. The raw signal supplied to the input terminal 1 is then supplied to a Hilbert conversion circuit 2 or the like for generating an analytic signal, where a real part R and an imaginary part I of an analytic signal are independently taken out.

Furthermore, the real part R and the imaginary part I are respectively supplied to square circuits 3, 4 and then supplied to an adder circuit 5. Subsequently, the added signal is supplied to a square-root circuit 6. Accordingly, the envelope component of the raw signal is taken out at the square-root circuit 6; here, a harmonic component is formed in the envelope component.

Then, the envelope component including the taken-out high-harmonic portion is supplied to a high-pass filter (HPF) 7, from the square-root circuit 6, where the harmonic component is taken out. On the other hand, a signal, from which the high frequency portion of the raw signal from the input terminal 1 is removed by a low-pass filter (LPF) 8, is prepared. The output signal from the high-pass filter 7 is added to the output signal from the low pass filter (LPF) 8 at an adder circuit 9 and the resultant signal is then output to an output terminal 10. Consequently, a signal on which a high frequency signal is superimposed (emphasized) is obtained at the output terminal 10.

As described above, the digital audio signal compressed according to MP3 ATRAC3 or the like and reproduced from the digital audio device is subjected to the interpolation of high frequency signals. In other words, the high-harmonic portion of an envelope component taken out at the high-pass filter 7 is added to a raw signal from which a high-frequency component is removed, thereby carrying out the interpolation of high frequency signals.

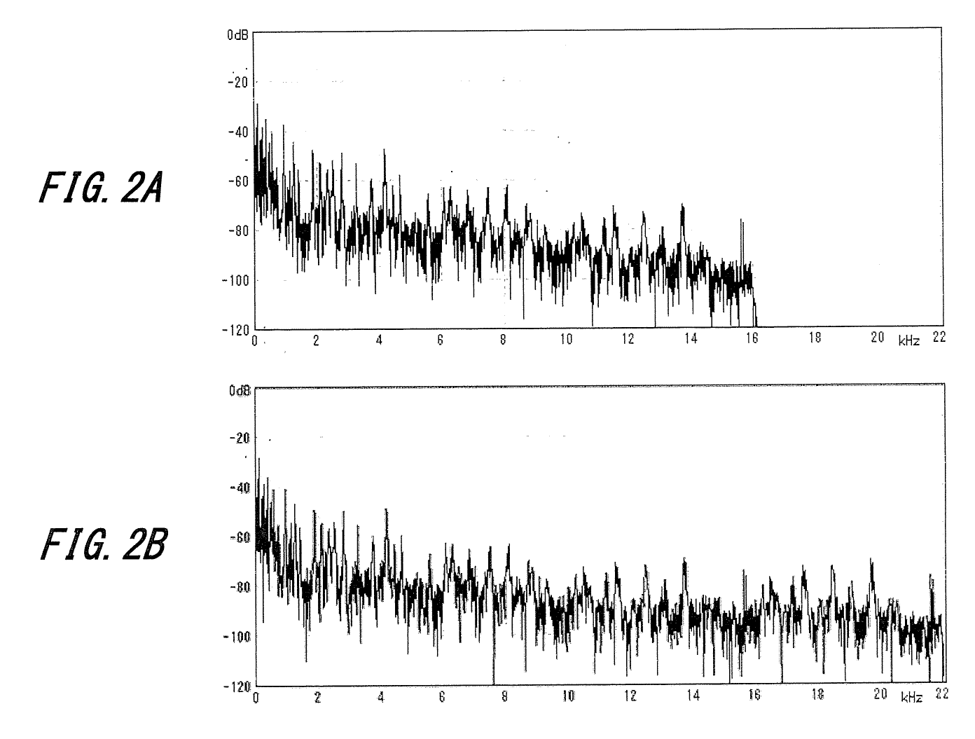

As described above, the harmonic component formed in the envelope component is approximated to the properties of the raw signal, so that interpolation of high frequency signals can be performed favorably by interpolating with the harmonic component. Here, FIG. 2A illustrates signals before the interpolation and FIG. 2B illustrates signals after the interpolation. As illustrated in FIG. 2, according to the present invention, interpolation can be performed favorably.

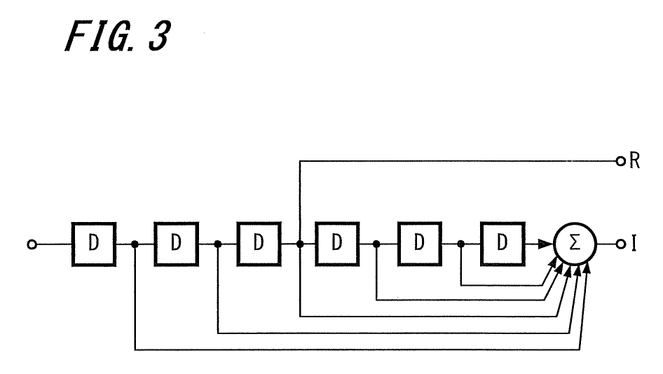

Furthermore, in the above configuration of the circuit as shown in FIG. 1, the Hilbert conversion circuit 2 may include, for example, a series of unit delay circuits D as shown in FIG. 3; and a real part R is obtained from the midpoint of the series and the outputs from the respective stages are added in a sigma circuit Σ, thereby obtaining an imaginary part I. Using such circuits, both the real part R and the imaginary part I of the analytic signal are independently obtained.

Furthermore, the square circuits 3, 4 and the adder circuits 5, 9 can easily be formed using digital computing units, respectively. In addition, the square-root circuit 6 may be complicated when the computing unit is formed. However, in the case of digital audio signals, the range of levels is restricted. Thus, for example, it can be easily formed by a look-up table using a read only memory, or the like.

In addition, both the high-pass filter 7 and the low-pass filter 8 can also be easily formed using digital filters, such as FIRs (Finit-duration Impulse Responses). Here, in FIG. 1, the low-pass filter 8 eliminating the high frequency portion of the raw signal is provided. However, the low-pass filter 8 may not be required when a digital audio signal supplied to the input terminal 1 is a signal previously passing through a low-pass filter.

Furthermore, the principle of the high frequency signal interpolation in accordance with the present invention as described above will be described as follows.

In general, for generating an envelope signal, peak detecting methods and so on have been employed. In this case, however, a frequency not less than that of a carrier component may not be generated. Thus, the Hilbert conversion is used to generate an analytic signal, so that a frequency not less than that of the raw signal can be calculated.

In other words, in general, amplitude may not be correctly obtained unless otherwise sampled at a time when the signal level becomes the maximum or the minimum. However, an analytic signal is generated using the Hilbert conversion and amplitude at a time of any sampling can be then calculated using the analytic signal. The principle of this case utilizes the properties of obtaining a vector quantity (sin²Θ+cos²θ=1).

Specifically, if Xr represents the real part of an analytic signal and Xi represents an imaginary part at an optional time, then amplitude A is represented by the following equation:

A=√(Xr*Xr+Xi*Xi)

Therefore, when a raw signal is considered as a signal with a kind of amplitude modification, it becomes possible to obtain amplitude at an optional time even the amplitude of the signal varies with time.

In this case, the modulated signal is assumed as the following equation:

g[n]=(1+s[n])(sin[w0n])

For simplifying the following equation, if (1+s[n]) is constant, then the signal is represented by the following equation:

g[n]=(1+s[n])(sin[w0n]+j cos[w0n])

Furthermore, in actual, it is also necessary to express a delay of M/2 if the order of the filter of the Hilbert conversion is defined as M. This delay can be offset when both the real part and the imaginary part are delayed for M/2.

Furthermore, if assuming (1+s[n]) ≧0, then the absolute value |g[n]| of the signal represented by this formula is represented by the following equation:

$$\begin{matrix}\vert g [ n ] \vert = ( 1 + s [ n ] ) * √ ( {sin}^{2} [ w 0 n ] + {cos}^{2} [ w 0 n ] ) \\ = ( 1 + s [ n ] )\end{matrix}$$

Therefore, it may be resulted in demodulation of the raw signal with amplitude modulation. In this case, however, if the input signal contains a DC component, then the signal is represented by the following equation:

g [n]=(1+s [n]) (sin[w0n])+Cdc

Then, if assuming that Cds is sufficiently smaller than (1+s[n]), then the absolute value of a signal obtained from such a signal can be approximated as follows:

|g[n]|∞(1+s[n])+Cdc* (sin[w0n])

Therefore, if the DC component is overlapped on the input signal, a component of a carrier wave will appear in the results of signal processing. Thus, there is a need of filtering using a high-pass filter.

As described above, more purified high-frequency interpolation can be carried out by solving a conventional problem leading to degradation of tone quality, which may be mapped to a high-frequency region even if the signal has a simple frequency spectrum when carrying out high-frequency interpolation.

Consequently, according to the computer program product for high frequency signal interpolation and the high frequency signal interpolation device of the present invention, a real part and an imaginary part of a raw signal are obtained and then an envelope component of amplitude of the raw signal is formed using the real part and the imaginary part of the raw signal. Subsequently, an envelope component of the raw signal is formed using the real part and the imaginary part and a high-harmonic portion of the envelope component is then taken out, followed by being added to the raw signal. Consequently, a favorable high frequency signal can be formed with an extremely simple configuration, so that practical high frequency signal interpolation can be carried out.

It should be noted that, the present invention is not limited to the embodiments described above, so that it may be modified in various ways without departing from the spirit of the present invention.

### DESCRIPTION OF REFERENCE NUMERALS

1 . . . INPUT TERMINAL, 2 . . . HILBERT CONVERSION CIRCUIT, 3, 4 . . . SQUARE CIRCUITS, 5, 9 . . . ADDER CIRCUITS, 6 . . . SQUARE ROOT CIRCUIT, 7 . . . HIGH-PASS FILTER, 8 . . . LOW-PASS FILTER, 10 . . . OUTPUT CIRCUIT, D . . . UNIT DELAY CIRCUIT, R . . . REAL PART, Σ. . . SIGMA CIRCUIT, I . . . IMAGINARY PART

1. (canceled)

2. (canceled)

3. (canceled)

4. (canceled)

5. (canceled)

6. A computer readable medium that stores a computer program for high frequency signal interpolation for allowing a computer to realize:
a function of obtaining a real part and an imaginary part of a raw signal;
a function of forming an envelope component of amplitude of the raw signal using the real part and the imaginary part; and
a function of taking out a high-harmonic portion of the envelope component and adding the high-harmonic portion to the raw signal.

7. A high frequency signal interpolation device, comprising:
a means for forming an envelope component of amplitude of a raw signal supplied to an input terminal using a real part and an imaginary part of the raw signal;
a means for taking out a high-harmonic portion of the formed envelope component; and
a means for adding the taken-out high-harmonic portion to the raw signal supplied to the input terminal.

8. The high frequency signal interpolation device according to claim 7, wherein
the means for forming the envelope component includes a means for obtaining the squares of the real part and the imaginary part of the raw signal respectively, adding the squares to each other, and obtaining a square root of a value resulting from the addition.

9. The high frequency signal interpolation device according to claim 7, wherein
the raw signal supplied to the input terminal is supplied to the adding means via a means for carrying out band limitation to exclude the high-harmonic portion.

10. The high frequency signal interpolation device according to claim 7, wherein
the band limitation is carried out in advance on the raw signal supplied to the input terminal so that the high-harmonic portion is excluded.
